(19) United States
(12) Patent Application Publication
(10) Pub. No.: US 2026/0297367 A1
(43) Pub. Date: Oct. 1, 2026

(54) METHOD FOR DEACTIVATING 1,2-BENZISOTHIAZOLIN-3-ONE IN A LATEX

(71) Applicant: ROHM AND HAAS COMPANY, Collegeville, PA (US)

(72) Inventors: Patrick E. Hartnett, Malvem, PA (US); Ethan C. Glor, Ambler, PA (US); Jeffrey S. Millman, Yardley, PA (US)

(21) Appl. No.: 19/477,634

(22) PCT Filed: Apr. 17, 2024
(86) PCT No.: PCT/US2024/024851

§ 371 Date: Oct. 22, 2025

Related U.S. Application Data
(60) Provisional application No. 63/504,803, filed on May 30, 2023.

(51) Int. Cl. C09D 121/02; C08K 3/20; C08K 5/47; C09D 7/61; C09D 7/63

(52) U.S. Cl. CPC C09D 121/02; C08K 3/20; C08K 5/47; C09D 7/61; C09D 7/63

(57) ABSTRACT

The present invention is a method comprising the step of contacting a latex containing from 100 ppm to 2000 ppm of 1,2-benzisothiazolin-3-one with an effective amount of hydrogen peroxide to reduce the concentration of the 1,2-benzisothiazolin-3-one to less than 50 ppm. The method is useful for providing a way to reduce BIT to safe levels prior to combining the latex with a finally formulated product.

### BACKGROUND OF THE INVENTION

The present invention is a method for deactivating 1,2-benzisothiazolin-3-one in a latex with hydrogen peroxide. Isothiazolinones such as methylisothiazolone (MIT), chloromethylisothiazolone (CMIT), and 1,2-benzisothiazolin-3-one (BIT) are commonly used preservatives for aqueous dispersions of polymer particles (latexes), but are currently under intense scrutiny because they are known skin sensitizers. Therefore, there is a need to balance the dual requirements of latex preservation with environmental, health, and safety concerns.

One approach for addressing the need is to preserve the latex with an isothiazolinone, then degrade or otherwise deactivate the preservative before it is used in the final paint formulation. For example, DE19810819A1 discloses the degradation of 400 ppm of BIT using >6000 ppm of sodium thiosulfate. However, the presence of a substantial amount of a salt is likely to adversely impact the properties of the subsequent paint formulation. Accordingly, there continues to be a need to reduce the concentration of BIT in a latex in a manner that preserves the properties of a paint formulation that uses the treated latex.

### SUMMARY OF THE INVENTION

The present invention addresses a need in the art by providing a method comprising the step of contacting a water-borne composition comprising a dispersion of polymer particles and from 100 ppm to 2000 ppm of 1,2-benzisothiazolin-3-one, based on the weight of the polymer particles, with an effective amount of hydrogen peroxide to reduce the concentration of the 1,2-benzisothiazolin-3-one to less than 50 ppm. The method provides a simple and relatively fast way of reducing the concentration of BIT in a latex to acceptable levels.

### DETAILED DESCRIPTION OF THE INVENTION

The present invention is a method comprising the step of contacting a water-borne composition comprising a dispersion of polymer particles and from 100 ppm to 2000 ppm of 1,2-benzisothiazolin-3-one, based on the weight of the polymer particles, with an effective amount of hydrogen peroxide to reduce the concentration of the 1,2-benzisothiazolin-3-one to less than 50 ppm.

The amount of hydrogen peroxide required to reduce the concentration of BIT in the water-borne dispersion, preferably an aqueous dispersion of polymer particles (i.e., a latex) or a coating formulation comprising the latex, to less than 50 ppm or less than 20 ppm or less than 10 ppm, based on the weight of the polymer particles, depends on the initial concentration of BIT in the latex. Examples of suitable latexes include acrylic, styrene-acrylic, and vinyl-ester latexes.

Coating formulations comprise one or more additional components including rheology modifiers such as hydrophobically modified ethylene oxide urethane polymers (HEURs), hydroxyethyl celluloses (HECs), alkali swellable emulsions (ASEs), and hydrophobically modified alkali swellable emulsions (HASEs); surfactants; dispersants; extenders such as calcium carbonate, mica, clay, and nepheline syenite; inorganic opacifying pigments such as TiO₂; organic opacifying pigments such as opaque polymer particles; defoamers, and colorants.

In general, an effective amount of hydrogen peroxide, based on the weight of the polymer particles, is in the range of from 100 ppm or from 200 ppm, to 2000 ppm or 1200 ppm or to 600 ppm, and the time required to reduce the concentration of the BIT to acceptable levels is in the range of from 8 hours or from 10 hours or from 15 hours, to 72 hours or to 48 hours or to 32 hours. The conversion can be conveniently carried out under ambient conditions.

### EXAMPLES

### Examples 1 and 2—Preparation of Latex Containing BIT and Hydrogen Peroxide

RHOBARR™ 110 Barrier Coating (50 wt % solids, A Trademark of The Dow Chemical Company or its Affiliates) with a BIT concentration of 320.7 ppm (based on the weight of the latex) was combined with hydrogen peroxide (250 ppm or 500 ppm, based on the weight of the latex) with stirring at ambient temperature. The blend was monitored by HPLC to measure the degradation of the BIT.

Table 1 shows the effect of the presence of hydrogen peroxide on the degradation of BIT over 32 h. BITₒ refers to the initial concentration of BIT in the sample; BIT₅ refers to the BIT concentration at 5 h, and BIT₃₂ refers to the BIT concentration at 32 h.

TABLE 1
Effect of Hydrogen Peroxide
Addition on BIT Concentration over Time

| Example | H₂O₂ ppm | BITₒ | BIT₅ | BIT₃₂ |
|---|---|---|---|---|
| Comp. 1 | 0 | 320.7 | 321.1 | 320.3 |
| Ex. 1 | 250 | 320.7 | 203.6 | 15.2 |
| Ex. 2 | 500 | 320.7 | 131.7 | 0 |

The data show that the concentration of BIT in the latex was reduced to acceptable levels in less than 32 h using relatively low amounts of hydrogen peroxide under ambient conditions.

1. A method comprising the step of contacting a water-borne composition comprising a dispersion of polymer particles and from 100 ppm to 2000 ppm of 1,2-benzisothiazolin-3-one, based on the weight of the polymer particles, with an effective amount of hydrogen peroxide to reduce the concentration of the 1,2-benzisothiazolin-3-one to less than 50 ppm.

2. The method of claim 1 where the concentration of the hydrogen peroxide is in the range of 100 ppm to 2000 ppm, based on the weight of the polymer particles, and the aqueous dispersion of polymer particles is a latex or a coating formulation comprising the latex.

3. The method of claim 1 where the concentration of the hydrogen peroxide is in the range of from 200 ppm to 1200 ppm, based on the weight of the polymer particles, and the aqueous dispersion of polymer particles is a latex or a coating formulation comprising the latex.

4. The method of claim 2 wherein the aqueous dispersion of polymer particles is a latex and wherein the reduction of the concentration of the 1,2-benzisothiazolin-3-one to less than 50 ppm occurs from 8 hours to 48 hours after the latex is contacted with the hydrogen peroxide.

5. The method of claim 3 wherein the aqueous dispersion of polymer particles is a latex and wherein the reduction of the concentration of the 1,2-benzisothiazolin-3-one to less than 50 ppm occurs from 10 hours to 32 hours after the latex is contacted with the hydrogen peroxide.

6. The composition of claim 1 where the aqueous dispersion of polymer particles is a coating formulation comprising a latex and one or more components selected from the group consisting of rheology modifiers; surfactants; dispersants; extenders; inorganic opacifying pigments;
organic opacifying pigments; defoamers; and colorants.

7. The composition of claim 6 where the concentration of the hydrogen peroxide is in the range of from 100 ppm to 2000 ppm, based on the weight of the polymer particles.

8. The composition of claim 6 where the concentration of the hydrogen peroxide is in the range of from 200 ppm to 1200 ppm, based on the weight of the polymer particles.
